(19) United States
(12) Patent Application Publication
(10) Pub. No.: US 2022/0089100 A1
(43) Pub. Date: Mar. 24, 2022

(54) ATTACHMENT DEVICES FOR SECURING A PHONE IN A VEHICLE

(71) Applicant: Apple Inc., Cupertino, CA (US)

(72) Inventors: Colin M. Ely, Sunnyvale, CA (US); Demetrios B. Karanikos, San Francisco, CA (US); Justin Chan, Freemont, CA (US)

(73) Assignee: Apple Inc., Cupertino, CA (US)

(21) Appl. No.: 17/030,870

(22) Filed: Sep. 24, 2020

(51) Int. Cl. B60R 11/02; H02J 7/00; H02J 50/10

(52) U.S. Cl. CPC B60R 11/0241; B60R 2011/0068; H02J 50/10; H02J 7/0044

(57) ABSTRACT

Attachment devices for securing phones and other electronic devices in a vehicle. One example can provide an attachment device that can include a stalk portion to attach to a surface or structure in a vehicle and an attachment portion, where the attachment portion includes an attachment face for mating with an electronic device. One or more attachment features can be located on the attachment face. An attachment device can further include power components for providing power to the electronic device.

### BACKGROUND

The number of types of electronic devices that are commercially available has increased tremendously the past few years and the rate of introduction of new devices shows no signs of abating. Devices such as tablet, laptop, desktop, and all-in-one computers, cell phones, storage devices, wearable-computing devices, portable media players, navigation systems, monitors, adapters, and others, have become ubiquitous.

As a result of the ubiquity and increasing functionality of these electronic devices, they now travel with users wherever they go. Also, they are often used during or in conjunction with many daily activities, either while performing an activity or in a manner that supplements an activity.

A common example of the latter is the activity of driving. An electronic device, such as a phone, can be very useful while driving to provide entertainment, such as music, or to provide information, such as map and navigation information. Such an electronic device can be useful for both a driver and a passenger of the vehicle.

Unfortunately, these phones or other electronic devices can move inside of a vehicle during sharp turns or sudden stops. A phone or other electronic devices can slip between a seat and a consol. These actions can simply annoy a user, or they can become dangerous. Accordingly, it can be desirable to provide attachment devices that can securely fix a position of a phone or other electronic device in a vehicle. That is, it can be desirable to securely attach a phone or other electronic device to a structure or surface of the vehicle.

Another type of distraction can arise when a battery on a phone or other electronic device runs low or is not able to power the device. Accordingly, it can be desirable that the attachment device have the capability of charging a phone or other electronic device.

Thus, what is needed are attachment devices for securing phones or other electronic devices in a vehicle, where the attachment devices can further provide charging power to the phones or other electronic devices.

### SUMMARY

Accordingly, embodiments of the present invention can provide attachment devices for securing phones or other electronic devices in a vehicle, where the attachment devices can further provide charging power to the phones or other electronic devices. An illustrative embodiment of the present invention can provide an attachment device that can include a stalk portion to attach to a surface or structure in a vehicle, such as a vent cover, dashboard, monitor, cup holder or other surface or structure. The attachment device can further include an attachment portion, where the attachment portion includes an attachment face for mating with an electronic device. One or more attachment features can be located on the attachment face or elsewhere on the attachment portion or the attachment device. The attachment features can be used to secure a phone or other device to the attachment device.

These and other embodiments of the present invention can provide various attachment features. These attachments features can include a magnetic structure. This magnetic structure can be a moving magnetic structure and can include a magnet protected by a housing. The moving magnetic structure can be positioned in a recess in the attachment face such that the moving magnetic structure moves in the recess in a direction that is orthogonal (or at least nonparallel) to the attachment face. The magnet can be attracted to a magnet in an electronic device that is, or is being, attached to the attachment face of the attachment device. For example, as the electronic device is brought into proximity, the moving magnetic structure can move into a position in the recess such that it is closer to the electronic device, thereby increasing the magnetic attraction between the magnet in the moving magnetic structure and the magnet in the electronic device. As the electronic device mates with the attachment device at the attachment face, the moving magnetic structure can be pushed back into the recess. The moving magnetic structure can then continue to hold the electronic device in position relative to the attachment face. The attachment device can be secured to a surface or structure of a vehicle such that the electronic device is held in place relative to the vehicle itself. The magnet can be a rare earth magnet, a magnetized ferromagnetic material, or other magnet. The magnet can instead be, or can include, a magnetically conducive structure that is not itself magnetic but can guide field lines from a magnet in the electronic device or elsewhere in the attachment device. The magnet can be implemented as a number of magnets that can be attracted to one or more magnets in the electronic device. The magnets in either or both the attachment device and electronic device can have various orientations. For example, they can have the same orientations, they can have alternating orientations, or their orientations can have other arrangements.

These and other embodiments of the present invention can provide other attachment features, such as a differential-pressure-based holding structure. The differential-pressure-based holding structure can include a flexible membrane that can be used to form a sealed area on a surface of an electronic device, where the sealed area has an internal pressure that is less than an ambient air pressure. This differential pressure can help to secure the electronic device in place. The differential-pressure-based holding structure can be a suction cup or other structure. The differential-pressure-based holding structure can be formed of a flexible membrane that is made of an elastomer, plastic, PVC plastic, rubber, silicon rubber, urethane, polyurethane, nitrile, neoprene, silicone, or other flexible material capable of maintaining a seal. The differential-pressure-based holding structure can be implemented as a number of differential-pressure-based holding structures, such as a number of suction cups. The differential-pressure-based holding structures can be placed around the recess in the attachment face. The differential-pressure-based holding structure can also or instead include one larger suction cup that can be formed as a ring around the recess.

These and other embodiments of the present invention can provide other attachment features, such as one or more high-friction or high-stiction surfaces. The high-friction surfaces can be formed as part of one or more suction cups or other differential-pressure-based holding structure, they can cover a surface of a moving magnetic structure, they can be located elsewhere on the attachment face, or any combination of these locations. The high-friction surfaces can engage a surface of an electronic device to increase a shear force needed to remove the electronic device from the attachment device. The high-friction surfaces can be formed of an elastomer, plastic, PVC plastic, rubber, silicon rubber, urethane, polyurethane, nitrile, neoprene, silicone, or other material. Some or all of the high-friction surfaces can also or instead be formed using an adhesive. Using an adhesive increases both a shear force and a normal force needed to remove the electronic device from the attachment device.

These and other embodiments of the present invention can provide other attachment features. For example, various hooks or other structures can be used to hold an electronic device in place relative to an attachment face of an attachment device.

These and other embodiments of the present invention can also provide various electronic components and circuits for communicating with or powering an electronic device. For example, an attachment device can include a coil and driving circuitry. The coil can be driven by the driving circuitry to induce a sympathetic current in a corresponding coil in the electronic device. Circuitry in the electronic device can use the induced current to charge a battery in or associated with the electronic device.

The electronic device can include driving circuitry and the corresponding coil. The drive circuitry can provide a drive current to the corresponding coil. The drive current to the corresponding coil can be modulated in order to transmit data to the attachment device. This modulation can be in amplitude, phase, frequency, or a combination thereof. For example, the drive current can be modulated in an on-off manner to transmit data. This data can be received by the attachment device and used in determining whether power should be delivered to the electronic device and in what amount. Data can similarly be transmitted from the attachment device to the electronic device as well.

Various software and control features can be implemented in these and other embodiments of the present invention. The software and control features can be implemented in an attachment device, an electronic device attached to the attachment device, or in other devices associated with the electronic device or a vehicle to which the attachment device is attached, by circuitry or components in an area surrounding the vehicle or elsewhere, or by a combination of these.

Various events can occur while driving a vehicle. Information regarding these various events can be detected by an attachment device, an electronic device attached to the attachment device, or other electronic devices circuits or components in or associated with these devices or a vehicle to which the attachment device is attached, or other electronic devices, circuits, or components in the surrounding environment or elsewhere. Detected information regarding these various events can be processed by one or more of the attachment device, the electronic device, or other electronic devices, circuits, or components, in or associated with these devices or a vehicle to which the attachment device is attached, or other electronic devices, circuits, or components in the surrounding environment or elsewhere. The processed information can then be used by one or more of these devices, circuits, or components. Depending on the event, resolving the event might or might not involve driver or passenger interaction.

While these and other embodiments of the present invention can be particularly well-suited to securing a phone in place relative to an interior of a vehicle (or other mobile locations, such a train, plane, bicycle, motorcycle, jet ski, or other conveyance), other devices, such as tablet, laptop, desktop, and other computers, cell phones, storage devices, wearable-computing devices, portable media players, navigation systems, monitors, adapters, and others can be secured in place in a vehicle or other conveyance, such as a train or plane, or other fixed or mobile location.

In these and other embodiments of the present invention, portions of the attachment devices can be nonconductive. These nonconductive portions, such as a housing for the attachment portion and stalk, can be formed using injection or other molding, 3-D printing, machining, or other manufacturing process. They can be formed of silicon or silicone, rubber, hard rubber, plastic, nylon, liquid-crystal polymers (LCPs), or other nonconductive material or combination of materials.

These and other embodiments of the present invention can provide attachment devices that can be used to secure various types of devices, such as portable computing devices, tablet computers, desktop computers, laptops, all-in-one computers, cell phones, wearable-computing devices, storage devices, portable media players, navigation systems, monitors, power supplies, adapters, remote control devices, audio devices, chargers, and other devices in place in a vehicle or other conveyance, such as a train or plane, or other fixed or mobile location.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates an attachment device according to an embodiment of the present invention;

FIG. 2 through FIG. 4 illustrate a mating sequence between an electronic device and an attachment device according to an embodiment of the present invention;

FIG. 5 illustrates an electronic device being detached from an attachment device according to an embodiment of the present invention;

FIG. 6 illustrates a flowchart of an operation of an attachment device according to an embodiment of the present invention; and

FIG. 7 illustrates a flowchart of an operation of an attachment device according to an embodiment of the present invention.

### DESCRIPTION OF ILLUSTRATIVE EMBODIMENTS

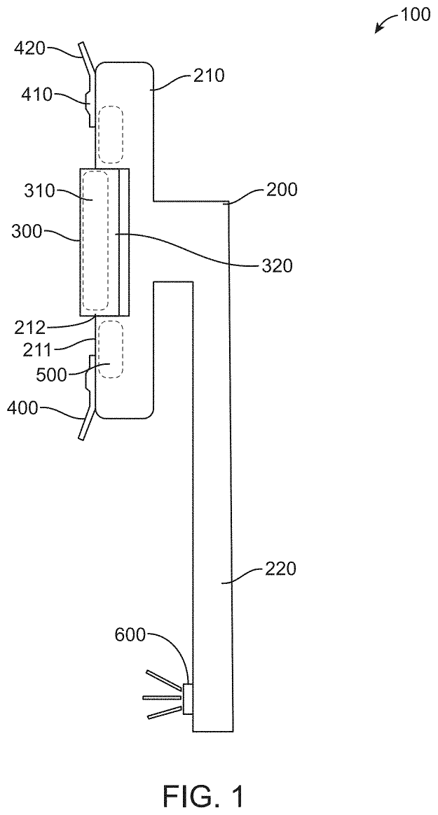

FIG. 1 illustrates an attachment device for securing a phone in a vehicle according to an embodiment of the present invention. This figure, as with the other figures, is shown for illustrative purposes and does not limit either the embodiments of the present invention or the claims.

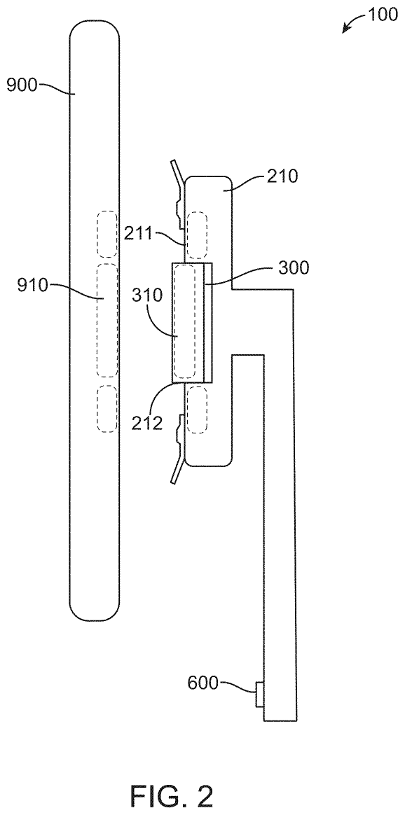

Attachment device 100 can include body 200. Body 200 can include attachment portion 210 and stalk 220. Stalk 220 can include structures (not shown) for attaching to a surface or structure in a vehicle such as a dashboard, vent, cup holder, or other surface or structure. Stalk 220 can include light-emitting diode (LED) 600. LED 600 can illuminate when electronic device 900 (shown in FIG. 2) is mated to attachment device 100. Attachment portion 210 can include recess 212 located in attachment face 211. Attachment face 211 can support a number of attachment features for securely attaching electronic device 900.

These attachment features can include movable magnetic structure 300. Movable magnetic structure 300 can include magnet 310 supported and protected by housing 320. Movable magnetic structure 300 can move in recess 212 in a lateral or horizontal direction (as drawn.) That is, movable magnetic structure 300 can move in a horizontal direction that is at least approximately orthogonal to the vertically-oriented attachment face 211. In these and other embodiments the present invention, movable magnetic structure 300 can move in a direction that is nonparallel to attachment face 211. In these and other embodiments of the present invention, movable magnetic structure can move in a direction that is parallel to attachment face 211. Movable magnetic structure 300 can include one, two, three, or more than three magnets. These magnets can be located in recess 212 or they can be located in more than one recess in attachment face 211 or elsewhere on or in attachment device 100. These magnets can have various orientations relative to each other, for example to improve the magnetic attraction to one or more corresponding magnets in electronic device 900.

The attachment features can further include a differential-pressure-based holding structure 400. The attachment features can further include a number of differential-pressure-based holding structures 400. These differential-pressure-based holding structures 400 can be placed at various locations on attachment face 211, or they can be placed elsewhere on attachment device 100, or both. In this example, side views of two differential-pressure-based holding structures 400 are shown. These two differential-pressure-based holding structures can be side views of one larger circular differential-pressure-based holding structure 400 that can encircle recess 212, or they can be side views of two individual differential-pressure-based holding structures 400.

In these and other embodiments of the present invention, the differential-pressure-based holding structures 400 can be suction cups or other flexible membranes 420 capable of maintaining a sealed area along a surface of electronic device 900, where the sealed area has an internal pressure that is less than an ambient air pressure. This differential pressure can help to secure electronic device 900 in place against attachment face 211. The flexible membranes 420 can be formed of elastomer, plastic, PVC plastic, rubber, silken rubber, urethane, polyurethane, nitrile, neoprene, silicone, or other flexible material capable of maintaining a seal.

The attachment features can further include a high-friction or high-stiction surface 410. The attachment features can further include a number of high-friction or high-stiction surfaces 410. These high-friction or high-stiction surfaces 410 can increase a sheer force that is necessary to remove electronic device 900 from attachment device 100. In this example, the high-friction or high-stiction surfaces 410 are shown as being formed as part of or formed on a portion of differential-pressure-based holding structure 400. In these and other embodiments of the present invention, the high-friction or high-stiction surfaces 410 can be formed separately from flexible membranes 420 of differential-pressure-based holding structures 400. In these and other embodiments of the present invention, high-friction or high-stiction surfaces 410 can be formed of an adhesive. Using an adhesive can increase both a normal and sheer force necessary to remove electronic device 900 from attachment device 100.

The attachment features can include other structures, such as hooks or extensions (not shown) to physically restrain electronic device 900 in place against attachment device 100. The hooks can hold with a force that can be overcome by a user to disconnect electronic device 900 from attachment device 100. These and other embodiments of the present invention can include one or more of these various attachment features in various combinations.

Attachment device 100 can further include LED 600. LED 600 can be one or more LEDs, or other status or other types of indicators. LED 600 can be used to indicate an attachment of electronic device 900 to attachment device 100. For example, LED 600 can be illuminated to indicate an attachment of electronic device 900 to attachment device 100.

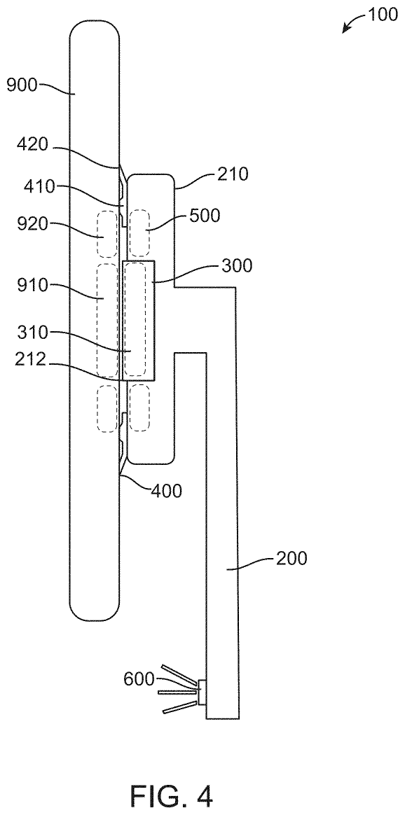

In these and other embodiments of the present invention, attachment device 100 can include circuits and devices for transferring power to, and communicating with, electronic device 900. For example, coil 500 in attachment device 100, along with additional circuitry (not shown) can provide power to electronic device 900. Also, coil 500, along with the additional circuitry, can receive information from electronic device 900. Typically, this can occur once electronic device 900 is mated with attachment device 100. A connector (not shown) on attachment device 100 can connect to through a cable to a power source of a vehicle, or a tethered cable (not shown) attached to attachment device 100 can connect to a power source of the vehicle. The vehicle power source can power coil 500 and its additional circuitry. The operation of coil 500 and the additional circuitry is described further in FIG. 4.

FIG. 2 through FIG. 4 illustrate a mating sequence between an electronic device and an attachment device according to an embodiment of the present invention. In FIG. 2, electronic device 900 has been brought into proximity of attachment device 100. Magnet 310 in movable magnetic structure 300 can be attracted to magnet 910 in the electronic device 900. As a result of this attraction, magnet 310 can move in recess 212 of attachment portion 210 towards magnet 910. This movement can increase the magnetic attraction between magnet 310 and magnet 910, which can assist the user in aligning electronic device 900 to attachment device 100. At this time, no connection has been made, so LED 600 can remain off.

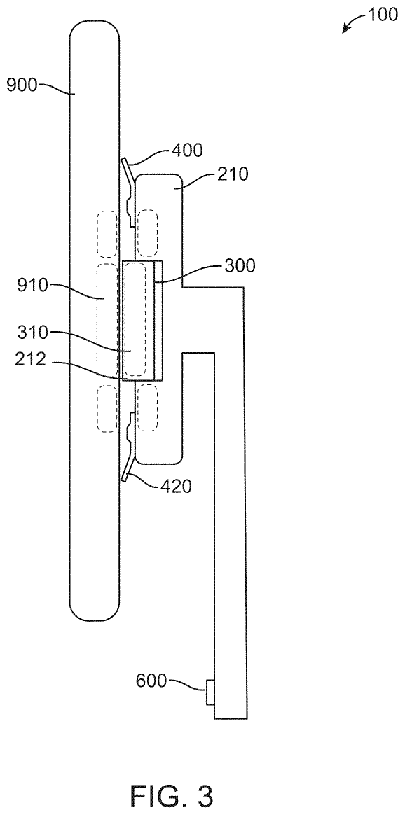

In FIG. 3, electronic device 900 can physically engage movable magnetic structure 300. Movable magnetic structure 300 can be positioned in recess 212 of attachment portion 210 towards magnet 910 of electronic device 900. Flexible membranes 420 of differential-pressure-based holding structures 400 can begin to engage electronic device 900. As before, LED 600 can remain off since electronic device 900 has yet to be attached to attachment device 100.

In FIG. 4, electronic device 900 can be attached to attachment device 100. Movable magnetic structure 300 can be pushed by electronic device 900 deeper into recess 212 in attachment portion 210 of body 200. Magnet 310 can be attracted to magnet 910 in the electronic device 900 thereby securing electronic device 900 in place. Flexible membranes 420 and high-friction or high-stiction surfaces 410 of differential-pressure-based holding structures 400 can form seals against electronic device 900, thereby further securing electronic device 900 in place. That is, flexible membrane 420 and high-friction or high-stiction surface 410 can create a low-pressure region against a surface of electronic device 900, thereby securing electronic device 900 to attachment face 211 of attachment portion 210 of body 200.

Circuitry (not shown) in electronic device 900 can provide currents to coil 920. These currents can generate sympathetic currents in coil 500 in attachment device 100. These sympathetic currents in coil 500 can be read by circuitry (not shown) in attachment device 100. These currents can be modulated in amplitude, phase, or frequency to convey data from electronic device 900 to attachment device 100. This data can include charge status, identification, authorization, information regarding power receiving capability, update information, or other types of information or data. For example, electronic device 900 can inform attachment device 100 of its charging status and power receiving capability.

In return, the circuitry in attachment device 100 can generate currents in coil 500. These currents can induce sympathetic currents in coil 920. These sympathetic currents in coil 920 can be used by electronic device 900 to charge a battery (not shown) in or associated with electronic device 900. Since a connection between electronic device 900 and attachment device 100 has been made, LED 600 can be illuminated by LED driving circuitry (not shown) in attachment device 100.

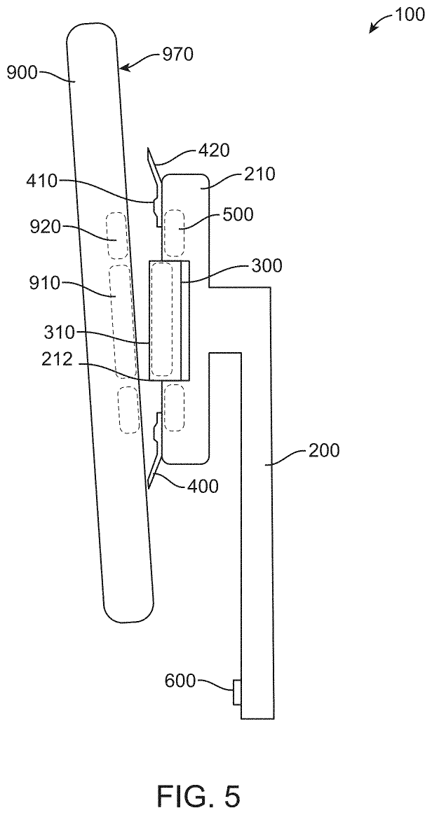

FIG. 5 illustrates an electronic device being detached from an attachment device according to an embodiment of the present invention. In this example, a force acting in a direction 970 is shown detaching electronic device 900 from attachment device 100. The low-pressure regions created by flexible membranes 420 and high-friction or high-stiction surfaces 410 of differential-pressure-based holding structures 400 have been broken. Movable magnetic structure 300 can move forward in recess 212 in attachment portion 210 of housing 200 as a result of magnet 910 being moved away from magnet 310. The breaking of the seals formed by differential-pressure-based holding structures 400 and the reduced magnetic attraction caused by the movement of magnet 910 away from magnet 310 can allow electronic device 900 to be detached from attachment device 100. Communications and power transfer between coil 920 and related circuitry (not shown) in electronic device 900 and coil 500 and related circuitry (not shown) in attachment device 100 can cease. As a result, LED 600 can be returned to a non-illuminated state by LED driving circuitry (not shown) in attachment device 100.

Various software and control features can be implemented in these and other embodiments of the present invention. The software and control features can be implemented in electronic device 900, in attachment device 100, or in other devices associated with electronic device 900 or a vehicle to which attachment device 100 is attached, by circuitry or components in an area surrounding the vehicle or elsewhere, or by a combination of these. Examples are shown in the following figures.

In these and other embodiments of the present invention, it can be desirable that electronic devices in a vehicle not unduly distract a driver. Accordingly, it can be desirable for these electronic devices to enter a mode where they can be of beneficial use but not be a distraction. A flowchart showing one example is shown in the following figure.

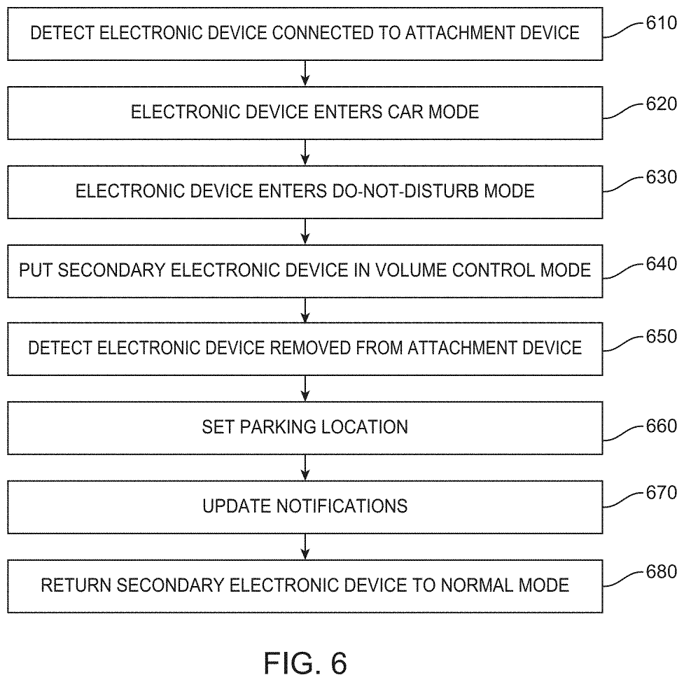

FIG. 6 illustrates a flowchart of an operation of an attachment device according to an embodiment of the present invention. In act 610, attachment device 100 (shown in FIG. 4) can detect that electronic device 900 (shown in FIG. 4), which can be a phone or other electronic device, is attached to attachment device 100. In act 620, electronic device 900 can enter a car mode. This car mode can be one where navigation, entertainment, or other information is displayed for a driver or passenger. Electronic device 900 can also enter a do-not-disturb mode where texts, email notifications, and other similar information might not be provided to a driver or passenger. This information can also be blocked in act 640 from secondary electronic devices such as a watch (not shown) that can be associated with electronic device 900. The secondary electronic devices might also be put in a beneficial but not distracting mode, such as a mode where the secondary electronic device can control an audio volume, or other parameter.

In act 650, a removal of electronic device 900 from attachment device 100 can be detected. Parking location information can be set in the phone in act 660. Notifications, which had been held in abeyance, can be provided to the driver or passenger in act 670. Similarly, secondary electronic devices, such as a watch, can return to a normal mode in act 680.

Various events can occur while driving a vehicle. Information regarding these various events can be detected by attachment device 100, electronic device 900, or other electronic devices circuits or components in or associated with these devices or a vehicle to which attachment device 100 is attached, or other electronic devices, circuits, or components in the surrounding environment or elsewhere, or a combination of these. Detected information regarding these various events can be processed by one or more of attachment device 100, electronic device 900, or other electronic devices, circuits, or components, in or associated with these devices or a vehicle to which attachment device 100 is attached, or other electronic devices, circuits, or components in the surrounding environment or elsewhere, or a combination of these. The processed detected information can then be used by any of these devices, circuits, or components. Depending on the event, resolving an event might or might not involve driver or passenger interaction. An example is shown in the following figure.

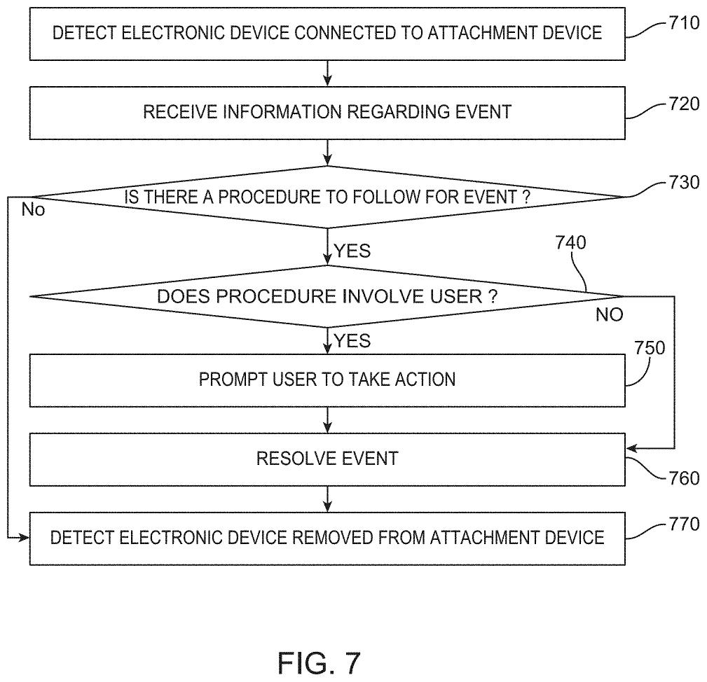

FIG. 7 illustrates a flowchart of an operation of an attachment device according to an embodiment of the present invention. In act 710, an attachment of electronic device 900 (shown in FIG. 4) to attachment device 100 (shown in FIG. 4) can be detected. In act 720, attachment device 100 can receive information regarding an event. The event can related to electronic device 900 and attachment device 100, for example, the event can be a detection that electronic device 900 is about to become detached from attachment device 100 or that a charging cable has become detached from attachment device 100. The event can be related to the vehicle itself, for example a tire pressure can be low or a possible collision can be detected. The event can be environmental or ambient, for example an approaching ambulance, weather change, or emergency beacon can be detected.

This event information can be provided by circuitry or components in attachment device 100 itself. For example, attachment device 100 can include magnetometers, accelerometers, strain gauges, sensors, or other circuits or components (not shown) that can provide this information. The information also or instead be provided by electronic device 900, by secondary electronic devices associated with electronic device 900, by other circuits or components in or associated with a vehicle to which attachment device 100 is attached, or other circuits or components in the surrounding environment or elsewhere, or a combination of these. For example, the information can be provided by nearby sensors, such as sensors at nearby intersections or sensors in nearby vehicles, or by remote sensors, such as remote sensors or software working in conjunction with nearby internet connected cameras.

In act 730, it can be determined whether there is a defined procedure to follow for the event. This determination can be made by attachment device 100, electronic device 900, by attachment device 100 in conjunction with electronic device 900 or by other circuits or components. If there is no defined procedure to follow, no action is taken. If there is a defined procedure to follow, a determination of whether the defined procedure involves a user, such as a driver or passenger, is made. If user intervention is not needed, the event can be resolved in act 760. If user interaction is needed, then a user can be prompted to take action in accordance with the defined procedure in act 750. Again, the event can then be resolved in act 760. Later, the removal of electronic device 900 from attachment device 100 can be detected in act 770.

While these and other embodiments of the present invention can be particularly well-suited to securing a phone in place relative to an interior of a vehicle (or other mobile locations, such a train, plane, bicycle, motorcycle, jet ski, or other conveyance), other devices, such as tablet, laptop, desktop, and other computers, cell phones, storage devices, wearable-computing devices, portable media players, navigation systems, monitors, adapters, and others can be secured in place in a vehicle or other conveyance, such as a train or plane, or other fixed or mobile location.

In these and other embodiments of the present invention, portions of the attachment devices can be nonconductive. These nonconductive portions, such as a housing for the attachment portion and stalk, can be formed using injection or other molding, 3-D printing, machining, or other manufacturing process. They can be formed of silicon or silicone, rubber, hard rubber, plastic, nylon, liquid-crystal polymers (LCPs), or other nonconductive material or combination of materials.

These and other embodiments of the present invention can provide attachment devices that can be used to secure various types of devices, such as portable computing devices, tablet computers, desktop computers, laptops, all-in-one computers, cell phones, wearable-computing devices, storage devices, portable media players, navigation systems, monitors, power supplies, adapters, remote control devices, audio devices, chargers, and other devices in place in a vehicle or other conveyance, such as a train or plane, or other fixed or mobile location.

As described, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. An attachment device comprising:
an attachment portion having an attachment face and comprising:
a coil near the attachment face for transferring power to an electronic device;
a recess in the attachment face; and
a differential-pressure-based holding structure; and
a movable magnetic structure located in the recess and capable of moving in a direction non-parallel to the attachment face.

2. The attachment device of claim 1 wherein the movable magnetic structure comprises a magnet.

3. The attachment device of claim 2 wherein the movable magnetic structure further comprises a housing supporting the magnet.

4. The attachment device of claim 3 wherein the movable magnet structure is capable of moving in a direction orthogonal to the attachment face.

5. The attachment device of claim 4 differential pressure-based holding structure comprises a plurality of suction cups.

6. The attachment device of claim 4 wherein the differential-pressure-based holding structure comprises a suction cup.

7. The attachment device of claim 6 wherein the suction cup comprises a high-friction portion.

8. The attachment device of claim 7 wherein the suction cup encircles the recess.

9. An attachment device comprising:
an attachment portion having an attachment face for mating with an electronic device, the attachment face supporting a plurality of attachment features, the attachment features comprising:
a movable magnetic structure;
a differential-pressure-based holding structure; and
a high-friction surface.

10. The attachment device of claim 9 wherein the high-friction surface is formed as a portion of the differential-pressure-based holding structure.

11. The attachment device of claim 10 wherein the differential-pressure-based holding structure comprises a plurality of suction cups.

12. The attachment device of claim 10 wherein the differential-pressure-based holding structure comprises a suction cup.

13. The attachment device of claim 12 wherein the movable magnetic structure comprises a magnet supported by a housing, the housing located in a recess in the attachment face.

14. The attachment device of claim 13 wherein the movable magnetic structure is capable of moving in a nonparallel direction to the attachment face.

15. The attachment device of claim 13 wherein the movable magnet structure is capable of moving in a direction orthogonal to the attachment face.

16. An attachment device comprising:
a stalk portion for attaching to a portion of a vehicle; and
an attachment portion having an attachment face for mating with an electronic device and comprising:
a coil for transferring power to the electronic device and for receiving data from the electronic device; and
a plurality of attachment features, the attachment features comprising:
a movable magnetic structure;
a differential-pressure-based holding structure; and
a high-friction surface.

17. The attachment device of claim 16 wherein the high-friction surface is formed as a portion of the differential-pressure-based holding structure.

18. The attachment device of claim 17 wherein the movable magnetic structure comprises a magnet supported by a housing, the housing located in a recess in the attachment face.

19. The attachment device of claim 18 wherein the movable magnetic structure is capable of moving in a nonparallel direction to the attachment face.

20. The attachment device of claim 19 wherein the differential-pressure-based holding structure comprises a suction cup.
